(19) United States
(12) Patent Application Publication
(10) Pub. No.: US 2025/0360902 A1
(43) Pub. Date: Nov. 27, 2025

(54) ELECTROHYDRAULIC BRAKE FOR A VEHICLE

(71) Applicant: KNORR-BREMSE Systeme für Nutzfahrzeuge GmbH, Munich (DE)

(72) Inventors: Falk HECKER, Markgröningen (DE); Jürgen STEINBERGER, Gröbenzell (DE); Matthias SEIDENSCHWANG, München (DE); Tobias SCHÖFBERGER, Mainburg (DE)

(21) Appl. No.: 18/874,442

(22) PCT Filed: May 31, 2023
(86) PCT No.: PCT/EP2023/064567

§ 371 Date: Dec. 12, 2024

(30) Foreign Application Priority Data
Jun. 13, 2022 (EP) 22178638.7

(51) Int. Cl. B60T 13/74; B60T 7/12; B60T 13/14; B60T 13/68

(52) U.S. Cl. CPC B60T 13/745; B60T 7/12; B60T 13/148; B60T 13/686; B60T 2201/03; B60T 2220/04; B60T 2270/10; B60T 2270/20; B60T 2270/30

(57) ABSTRACT

An electrohydraulic brake for a vehicle, which includes an electronic controller having an implemented regulation function, which is carried out during a braking operation as needed in at least one regulating cycle, wherein during the regulating cycle, at least one brake pressure reduction and at least one brake pressure build-up take place in at least one hydraulic brake actuator. The electrohydraulic brake includes a hydraulic fluid reservoir, a pump, and at least one pressure accumulator. The electronic controller controls at least the drive machine for the pump and/or the valve device.

The invention relates to an electrohydraulic brake for a vehicle according to claim 1.

Electrohydraulic brakes are brakes in which the braking intention of a driver is detected at a pedal by means of a sensor in a braking value generator, whereupon a control unit actuated using the sensor generates a pressure in a hydraulic braking system via a pressure generator, due to which the brakes carry out a braking intervention corresponding to the braking intention of the driver.

The object of the invention is to provide an energy-saving electrohydraulic brake of a vehicle, using which control processes can be carried out with a high level of dynamics. Furthermore, a vehicle having such an electrohydraulic brake is also to be provided.

This object is achieved according to the invention by the features of claims 1 and 17.

### DISCLOSURE OF THE INVENTION

The invention provides an electrohydraulic brake for a vehicle, which comprises at least the following:

a) an electronic controller having an implemented regulation function, which is carried out during a braking operation as needed in at least one regulating cycle, wherein during the regulating cycle, at least one brake pressure reduction and at least one brake pressure build-up take place in at least one hydraulic brake actuator,

b) the at least one hydraulic brake actuator, which generates a braking force depending on the controlled brake pressure,

c) a hydraulic fluid reservoir for storing hydraulic fluid,

d) a pump and a drive machine for the pump,

e) at least one pressure accumulator for pressurized storage of hydraulic fluid which originates from the hydraulic fluid reservoir,

f) flow connections between the at least one brake actuator, the hydraulic fluid reservoir, the pump, and the pressure accumulator, wherein

g) in at least one flow connection, a valve device at least partially controllable by the electronic controller is arranged, which controls a flow of hydraulic fluid in the at least one flow connection, wherein

h) the electronic controller controls at least the drive machine for the pump and/or the valve device such that during the at least one regulating cycle, hydraulic fluid flows back and forth or is conveyed back and forth between the at least one brake actuator and the pressure accumulator.

The electrohydraulic brake can comprise in particular a braking request device, which introduces signals for the beginning and the ending of the braking operation and for the degree of brake actuation of the brake in the electronic controller to control the braking process; the electronic controller then controls at least the drive machine for the pump and/or the valve device depending on these signals.

A force transmission from the drive machine to the hydraulic actuator, for example, a hydraulic brake cylinder

is effectuated by the hydraulics by virtue of the invention. The hydraulic force transmission is easily scalable, so that drive machines of different powers can be used. In the manner of an “energy recovery feature”, hydraulic fluid then flows back and forth or is in particular conveyed back and forth by the pump between the at least one brake actuator and the pressure accumulator during the at least one regulating cycle. Therefore, during the regulation, hydraulic energy is buffered in the pressure accumulator in the form of pressurized hydraulic fluid and withdrawn from the pressure accumulator and then fed back to the pressure accumulator again during the regulating cycles.

The pressure accumulator is preferably a high-pressure accumulator here, in which a first pressure prevails, which in particular is greater at least after a brake pressure reduction in the course of the at least one regulating cycle than a second pressure which prevails in the hydraulic fluid reservoir, because, for example, the pressure accumulator is subjected during the brake pressure reduction to pressure from the at least one brake actuator. The pressure accumulator insofar preferably represents a buffer for the hydraulic fluid, in which this is buffered under pressure.

In particular exclusively or also during the at least one regulating cycle, hydraulic fluid flows back and forth or is conveyed back and forth between the at least one brake actuator and the pressure accumulator.

Due to the higher pressure level in the pressure accumulator, a drive machine of the pump, for example an electric motor having relatively low power, is sufficient. Furthermore, the energy consumption during the regulation function is thus also advantageously low and the regulation function has a high level of dynamics. Not least, the pressure in the pressure accumulator can assist the brake pressure build-up in the at least one brake actuator in particular during longer braking operations, which last longer than a minimum duration.

Advantageous refinements of the invention are specified in the dependent claims.

The electronic controller is preferably designed so that, at least during the at least one regulating cycle, it controls the drive machine of the pump and/or the valve device

a) for the brake pressure reduction such that hydraulic fluid flows or is conveyed from the at least one brake actuator into the pressure accumulator, and

b) for the brake pressure build-up such that hydraulic fluid flows or is conveyed from the pressure accumulator into the at least one brake actuator.

The regulation function can also be designed such that at least during the at least one regulating cycle, at least one brake pressure maintenance following a brake pressure build-up or a brake pressure reduction is carried out, in which the electronic controller controls the drive machine of the pump and/or the valve device such that hydraulic fluid is retained in the at least one brake actuator.

According to one refinement, the electronic controller can control at least the drive machine for the pump and/or the valve device such that, in particular also with inactive regulation function, i.e. in particular when the regulation function is not carried out or activated,

a) for a brake pressure build-up, for example, at a beginning or during a or the braking operation in the at least one brake actuator, hydraulic fluid flows or is conveyed from the hydraulic fluid reservoir and/or from the pressure accumulator into the at least one brake actuator, and/or

b) for a brake pressure reduction, for example, at an ending of a or the braking operation, hydraulic fluid flows or is conveyed from the at least one brake actuator into the hydraulic fluid reservoir and/or into the pressure accumulator.

The brake pressure build-up and/or the brake pressure reduction then takes (take) place in the described manner without the regulation function being activated or taking effect, because its execution is not necessary or desired, for example. In other words, the pressure in the pressure accumulator can be used to assist a brake pressure build-up or as the exclusive pressure for the brake pressure build-up in the at least one brake actuator, even if the regulation function is not or is not yet active. The pressure prevailing in the at least one brake actuator can also be used during a brake pressure reduction in the at least one brake actuator in order to thus apply it to the pressure accumulator and/or the hydraulic fluid reservoir. If the pressure accumulator is subjected to the pressure, the pressure level in the pressure accumulator, which is then higher, can in turn be used for a brake pressure build-up.

The electrohydraulic brake can in particular comprise a braking request device, which introduces signals for the beginning and the ending of the braking operation and for the degree of brake actuation of the brake into the electronic controller to control the braking operation, and which comprises

a) a braking value generator actuatable by a driver of the vehicle, and/or

b) a driver assistance system and/or an autopilot.

Therefore, the braking value generator and/or the driver assistance system and/or the autopilot can generate a braking request signal to request the braking operation.

In the electrohydraulic brake, the pump can be a unidirectionally operable pump having a single conveyance direction, wherein then the electronic controller can control the drive machine of the unidirectionally operable pump such that the unidirectionally operable pump conveys hydraulic fluid in the single conveyance direction. The operation of the unidirectionally operable pump in the single conveyance direction can preferably take place for the brake pressure build-up, in particular during the at least one regulating cycle. Alternatively, the operation of the unidirectionally operable pump in the single conveyance direction can also take place for the brake pressure reduction, in particular during the at least one regulating cycle.

According to an alternative embodiment, the pump can also be designed as a bidirectionally operable pump, wherein the electronic controller controls the drive machine of the pump such that the bidirectionally operable pump

a) in a first conveyance direction, conveys hydraulic fluid from the hydraulic fluid reservoir and/or from the pressure accumulator into the at least one brake actuator, and

b) in a second conveyance direction opposite to the first conveyance direction, conveys hydraulic fluid from the at least one brake actuator into the pressure accumulator and/or into the hydraulic fluid reservoir.

In particular the operation of the bidirectionally operable pump, in particular during the at least one regulating cycle,

a) can take place in the first conveyance direction for the brake pressure build-up, and

b) can take place in the second conveyance direction for the brake pressure reduction.

The electronic controller can also control the drive machine of the pump at least during the at least one regulating cycle such that the pump is alternately operated between the first conveyance direction and the second conveyance direction for the brake pressure reduction and for the brake pressure build-up, in particular during the at least one regulating cycle.

In the electrohydraulic brake, the regulation function can comprise a wheel-individual (wheel-selective) or axle-individual (axle-selective) regulation function, in particular an antilock braking system (ABS), a traction control system (TCS), and/or an electronic stability program (ESP), which carries out a wheel-selective braking intervention depending on the vehicle situation if such an intervention is required to avoid skidding of the vehicle.

The electronic controller can also be designed such that it controls the drive machine of the pump and if needed the valve device during a filling phase in order to convey hydraulic fluid into the pressure accumulator until the pressure prevailing in the pressure accumulator is greater than a minimum pressure. Alternatively or additionally, the electronic controller can be designed such that it controls the drive machine of the pump and if needed the valve device during a filling phase in order to convey hydraulic fluid into the pressure accumulator during at least one brake pressure reduction, in particular during at least one regulating cycle, until the pressure prevailing in the pressure accumulator is greater than the minimum pressure.

The minimum pressure can preferably be in a range between 50 and 100 bar. The pressure accumulator is therefore preferably a high-pressure accumulator. In contrast, the hydraulic fluid reservoir is, for example, a low-pressure accumulator, having a pressure prevailing therein of approximately ambient pressure.

The valve device can also comprise at least one solenoid valve controlled by the electronic controller and can have a switching position in which the valve device establishes a flow connection between the at least one brake actuator and the pressure accumulator and/or the hydraulic fluid reservoir. The at least one solenoid valve in particular can be spring pre-tensioned in this one switching position and can assume this one switching position when deenergized (normally open). The at least one solenoid valve can then preferably be used for rapid force reduction and in case of fault (for example, deenergizing due to failure of the power supply or a fault in the controller), connects the at least one hydraulic brake actuator to the pressure accumulator and/or to the hydraulic fluid reservoir, by which a fail-silent functionality is provided.

The valve device can preferably comprise at least the following:

a) a check valve,

b) a 2/2 way solenoid valve,

c) a 3/2 way solenoid valve,

d) a 4/2 way solenoid valve.

The invention also relates to a vehicle having at least one above-described electrohydraulic brake.

### DRAWING

Exemplary embodiments of the invention are illustrated in the drawings and explained in more detail in the following description hereinafter. In the drawing:

FIG. 1 shows a schematic circuit diagram of an electrohydraulic brake according to a preferred embodiment of the invention;

FIG. 2 shows the electrohydraulic brake from FIG. 1 during the brake force build-up at the beginning and during a braking operation without active regulation function;

FIG. 3 shows the electrohydraulic brake from FIG. 1 during the brake force reduction at the ending of the braking operation without active regulation function;

FIG. 4 shows the electrohydraulic brake from FIG. 1 during the brake force reduction with active regulation function;

FIG. 5 shows the electrohydraulic brake from FIG. 1 during the brake force build-up with active regulation function;

FIG. 6 shows the electrohydraulic brake from FIG. 1 during a filling phase of a pressure accumulator;

FIG. 7 shows a schematic circuit diagram of an electrohydraulic brake according to a further embodiment of the invention.

### DESCRIPTION OF THE EXEMPLARY EMBODIMENTS

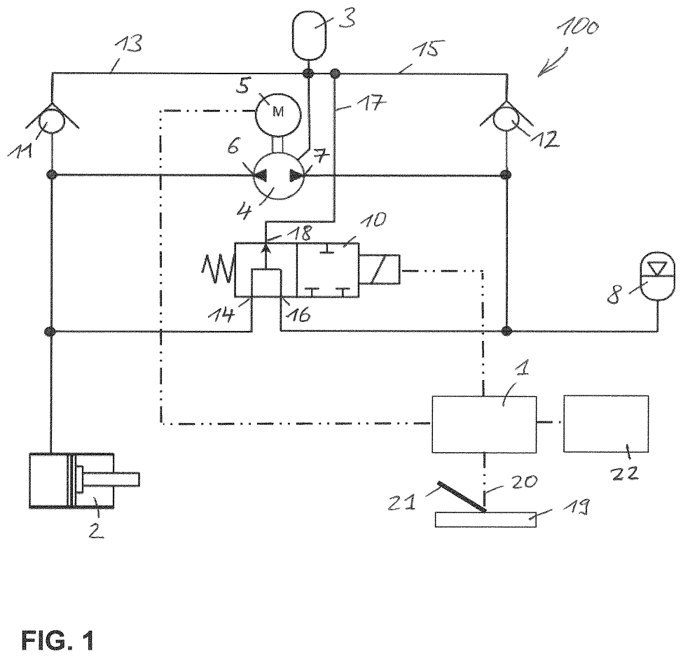

FIG. 1 shows a schematic circuit diagram of an electrohydraulic brake 100 according to a preferred embodiment of the invention.

The electrohydraulic brake 100 comprises an electronic controller 1 having an implemented regulation function, which is activated and carried out as needed during a braking operation in at least one regulating cycle. During a regulating cycle, at least one brake pressure reduction and at least one brake pressure build-up take place in at least one hydraulic brake actuator 2. The regulation function comprises here, for example, an antilock braking system (ABS), in which the brake slip is in particular regulated individually by wheel. The electronic controller 1 insofar represents a braking control unit of the electrohydraulic brake 100.

Furthermore, the electrohydraulic brake 100 comprises multiple brake actuators, of which only one brake actuator 2 is shown here as representative of the further brake actuators. The brake actuator 2 is formed here, for example, by a hydraulic disk brake having a hydraulic brake cylinder that can be loaded with hydraulic fluid and relieved of hydraulic fluid. The hydraulic brake actuator 2 generates a braking force at the relevant wheel depending on a brake pressure introduced therein. Such a brake actuator 2 is preferably assigned to each wheel of the vehicle, so that the wheels can be braked individually.

In addition, the electrohydraulic brake 100 comprises a hydraulic fluid reservoir 3 for the preferably unpressurized storage of hydraulic fluid, for example, under ambient pressure, and a pump 4, which is bidirectional here, for example, and is operable driven by a drive machine 5, for example, by an electric motor, depending on the rotational direction of the drive machine in two opposite pump directions. This means that in a first pump direction the suction side of the pump corresponds to the pressure side of the pump, when it is operated in the opposite second pump direction, and vice versa. The pump 4 therefore has a first connection 6, which then points toward the suction side or the pressure side of the pump 4 depending on the pump direction. This is also true for a second connection 7 of the pump 4.

Furthermore, the electrohydraulic brake comprises a pressure accumulator 8 for the in particular high-pressure storage of hydraulic fluid and flow connections between the at least one brake actuator 2, the hydraulic fluid reservoir 3, the pump 4, and the pressure accumulator 8.

Not least, the electrohydraulic brake 100 comprises a valve device 9, which here provides, for example, a 3/2 way solenoid valve 10 and a first check valve 11 as well as a second check valve 12.

The flow connections include a first flow connection 13 between the hydraulic fluid reservoir 3, the first connection 6 of the pump 4, a first connection 14 of the 3/2 way solenoid valve 10 and the at least one brake actuator 2, a second flow connection 15 between the hydraulic fluid reservoir 3, the second connection 7 of the pump 4, a second connection 16 of the 3/2 way solenoid valve 10, and the pressure accumulator 8, as well as a third flow connection 17 between the hydraulic fluid reservoir 3 and a third connection 18 of the 3/2 way solenoid valve 10.

In the first flow connection 13, the first check valve 11 is arranged such that it permits a flow from the hydraulic fluid reservoir 3 to the at least one brake actuator 2, to the first connection 6 of the pump 4, and to the first connection 14 of the 3/2 way solenoid valve 10, but prevents a flow in the opposite direction, namely from the at least one brake actuator 2 and/or from the first connection 6 of the pump and/or from the first connection 14 of the 3/2 way solenoid valve 10 into the hydraulic fluid reservoir 3.

In an analogous manner, in the second flow connection 15, the second check valve 12 is arranged such that it permits a flow from the hydraulic fluid reservoir 3 to the second connection 7 of the pump 4, to the pressure accumulator 8, and to the second connection 16 of the 3/2 way solenoid valve 10, but prevents a flow in the opposite direction, namely from the pressure accumulator 8 and/or from the second connection 7 of the pump 4 and/or from the second connection 16 of the 3/2 way solenoid valve 10 into the hydraulic fluid reservoir 3.

The 3/2 way solenoid valve 10 has a passage position shown in FIG. 1, in which the first connection 14, the second connection 16, and the third connection 18 are connected to one another, and a blocking position, in which a flow connection does not exist between any of the first, second, and third connections 14, 16, 18. In the passage position shown in FIG. 1, the at least one brake actuator 2 is directly connected to the hydraulic fluid reservoir 3 and the pressure accumulator 8. In the blocking position, these connections are interrupted. The 3/2 way solenoid valve 10 is preferably a “normally open” valve, wherein it is spring pre-tensioned in the passage position and then assumes this position when deenergized. In contrast, if it is energized by the electronic controller 1, it switches into the blocking position.

The 3/2 way solenoid valve 10 and the drive machine 5 of the pump 4 are controlled in a coordinated manner by an electronic controller 1 in order to circulate hydraulic fluid in the flow connections. The electronic controller 1 also has a signal connection for this purpose to an electrical braking value generator 19 of the electrohydraulic brake 100 via a signal line 20, which can be actuated here, for example, via a brake pedal 21 by a driver in order to introduce braking request signals into the electronic controller 1 depending on the actuation. It is provided here that braking request signals are generated not only by the driver-actuated braking value generator 19, but additionally or alternatively by a driver assistance system such as an adaptive cruise control (ACC) or an emergency braking assistant and/or by an autopilot and then introduced by a corresponding control unit 22 into the electronic controller 1 in order to trigger, control, and end braking operations.

Various situations or stages of braking operations illustrated in the figures are described hereinafter. Flows under a relatively low pressure are identified in the figures by dot-dash arrows and flows under a relatively high pressure are identified by dashed arrows.

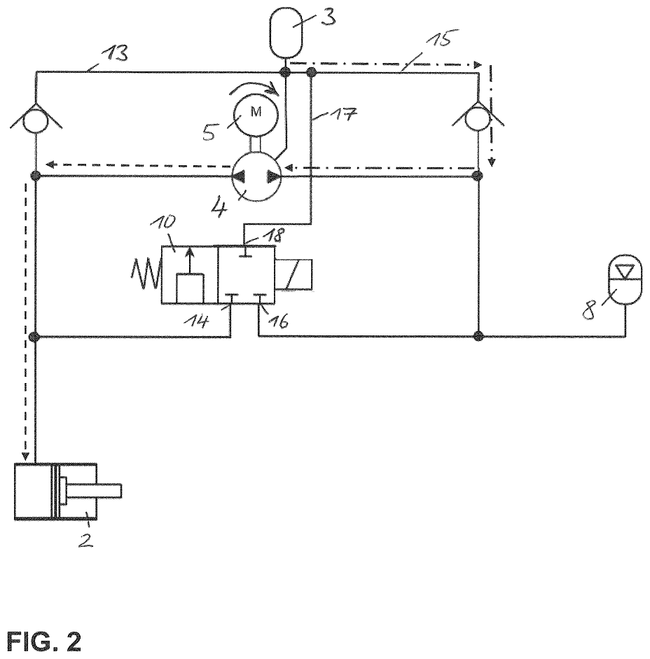

FIG. 2 shows the electrohydraulic brake 100 of FIG. 1 during the brake force build-up at the beginning and during a braking operation without active ABS regulation function, i.e. so that the wheels assigned to the brake actuators 2 do not excessively slip at the beginning and during the braking operation. The electronic controller 1 actuates the drive machine 5 of the pump 4 in order to drive it in a first pump direction symbolized by the arrow here, in which the pump 4 conveys hydraulic fluid via the second flow connection 15 out of the hydraulic fluid reservoir 3 and then via the first flow connection 13 into the at least one brake actuator 2. The first check valve 11 prevents hydraulic fluid from being conveyed from the first flow connection 13 back into the hydraulic fluid reservoir 3. Since the 3/2 way solenoid valve 10 is energized by the electronic controller 1 and is thus switched into the blocking position, the direct flow connection between the at least one brake actuator 2 and the pressure accumulator 8 as well as the hydraulic fluid reservoir 3 is blocked.

The first flow connection 13 is thus located on the pressure side of the pump 4, due to which the pressure in the first flow connection 13 is higher than on the suction-side second flow connection 15, due to which a brake pressure is built up in the at least one brake actuator 2 and therefore braking force is built up there.

If the braking force is to be kept constant over a certain period of time, for example, which arises, for example, from a corresponding actuation of the brake pedal 21 and a braking request signal arising therefrom, the 3/2 way solenoid valve 10 still remains in its blocking position, but the drive machine 5 can continue to drive the pump 4 in the first pump direction, but with reduced power or speed, for example, in order to compensate for leakage losses.

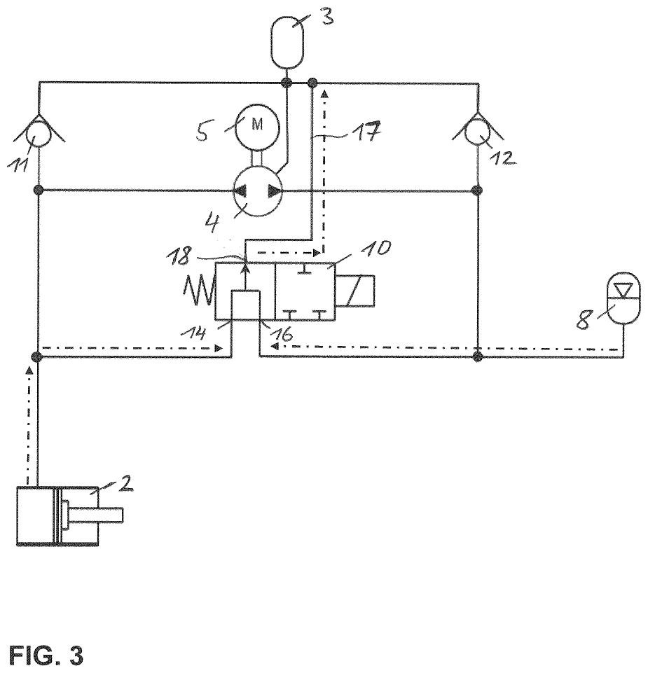

If the brake is now released at the end of the braking operation, the situation shown in FIG. 3 results, in which the 3/2 way solenoid valve 10 is switched from the blocking position into the passage position by the electronic controller 1. Hydraulic fluid then flows from the at least one brake actuator 2 through the open 3/2 way solenoid valve 10 via the third flow connection 17 back into the hydraulic fluid reservoir 3. The drive machine 5 of the pump 4 is switched off in this case.

If an impermissibly high brake slip occurs on at least one wheel of the vehicle during the described braking operation, the braking force at the affected wheel is reduced, maintained, and built up again in regulating cycles by the ABS regulation function implemented in the electronic controller 1. A regulating cycle, an ABS regulating cycle here, for example, therefore comprises a brake pressure reduction, a brake pressure maintenance, and a brake pressure build-up at the relevant brake actuator 2.

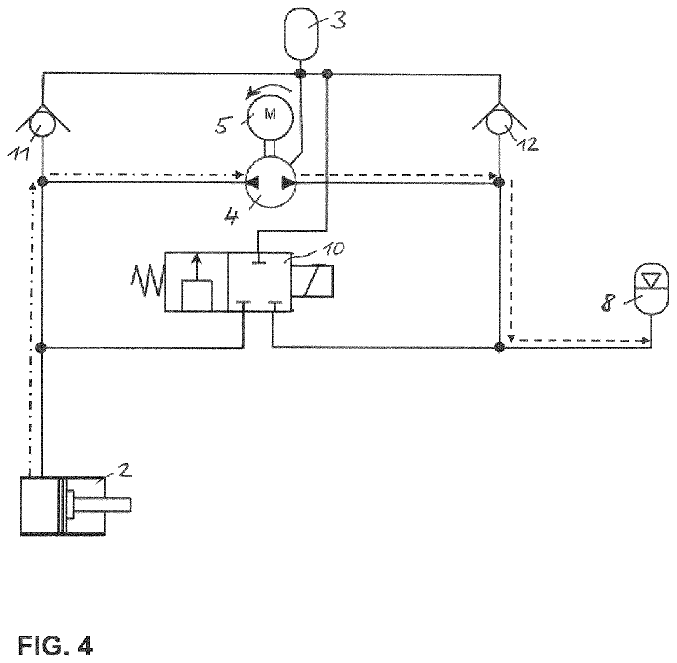

The brake pressure reduction in the course of the ABS regulating cycle is shown in FIG. 4. The electronic controller 1 controls or keeps the 3/2 way solenoid valve 10 in the blocking position and drives the drive machine 5 such that the pump 4 is driven in the second pump direction symbolized by the arrow. This ensures that hydraulic fluid is pumped from the at least one brake actuator 2 via the first flow connection 13 into the pressure accumulator 8, in which the pressure thereupon increases.

If subsequent pressure maintenance is part of the ABS regulating cycle, the drive machine 5 is stopped, for example, by the electronic controller 1.

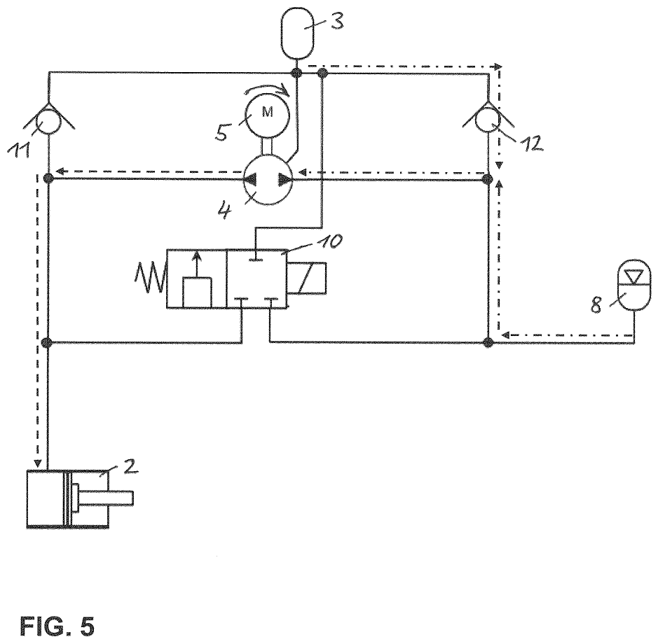

For a subsequent brake pressure build-up in the course of the ABS regulating cycle, the rotational direction of the drive machine 5 of the pump 4 is now reversed, so that the pump 4 is now driven by the drive machine 5 rotating in the opposite direction symbolized by the arrow in FIG. 5 and the pump 4 then pumps the hydraulic fluid in the first pump direction out of the pressure accumulator 8 and the hydraulic fluid reservoir 3 into the at least one brake actuator 2. The pressure previously increased in the course of the brake pressure reduction is then preferably used for the following brake pressure build-up.

Therefore, during the regulation function, upon each change from a brake pressure reduction to a brake pressure build-up and vice versa, hydraulic fluid is conveyed back and forth into the pressure accumulator 8 with pressure increase therein and out of the pressure accumulator 8 with pressure reduction therein by a change of the drive direction of the bidirectionally operating pump 4. Hydraulic fluid therefore flows back and forth like an energy recovery system between the at least one brake actuator 2 and the pressure accumulator 8 and is in particular conveyed back and forth by the pump 4 in the exemplary embodiment described here.

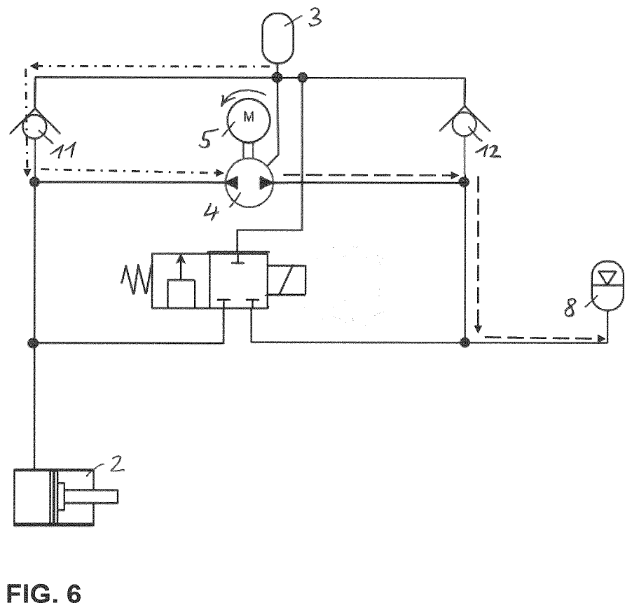

FIG. 6 shows a filling phase of the pressure accumulator 8, as can be carried out temporally before a regulating cycle by the electronic controller 1, for example. For this purpose, the 3/2 way solenoid valve 10 is again controlled into the blocking position and the drive machine 5 is driven in such a way that the pump 4 is driven in the second pump direction symbolized by the arrow, so that hydraulic fluid is pumped from the hydraulic fluid reservoir 3 into the pressure accumulator 8, so that a relatively high pressure of, for example, 50 to 100 bar can build-up therein, which can then be used, for example, for the brake pressure build-up within an (in particular coming or later) regulating cycle or also to assist a general brake pressure build-up without active regulation function as described in FIG. 2.

If a malfunction now occurs in the electronics, for example, in the course of a power failure, the 3/2 way solenoid valve 10 is deenergized and then switches in a spring pre-tensioned manner into its passage position. As a result, hydraulic fluid then flows from the at least one brake actuator 2 through the open 3/2 way solenoid valve 10 via the third flow connection 17 into the hydraulic fluid reservoir 3, due to which the at least one brake actuator 2 is set force-free and a fail-silent function is provided.

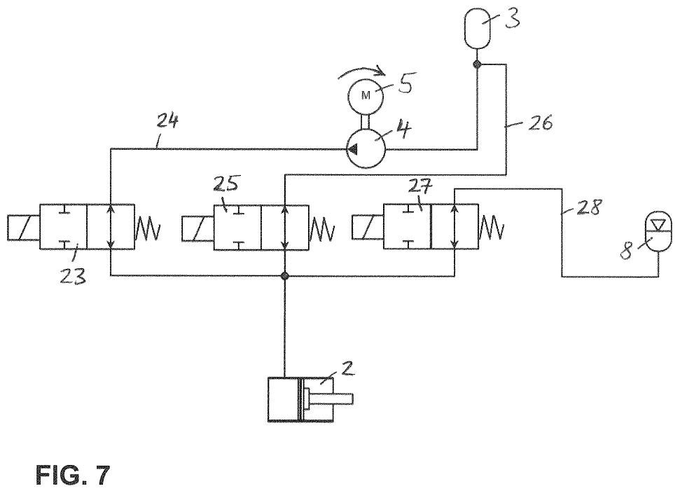

FIG. 7 shows a schematic circuit diagram of an electrohydraulic brake 100 according to a further embodiment of the invention. In contrast to the embodiment of FIG. 1, a merely unidirectionally operable pump 4 is provided therein.

Furthermore, instead of a 3/2 way solenoid valve, three 2/2 way solenoid valves are provided, namely a first 2/2 way solenoid valve 23 in a first flow connection 24, to which the hydraulic fluid reservoir 3, the pump 4, and the at least one brake actuator 2 are connected, a second 2/2 way solenoid valve 25 in a second flow connection 26 between the hydraulic fluid reservoir 3 and the at least one brake actuator 2, and a third 2/2 way solenoid valve 27 in a third flow connection 28, to which the pressure accumulator 8 and the at least one brake actuator 2 are connected. The three flow connections 24, 26, and 28 are connected to one another on the side of the brake actuator 2. The three 2/2 way solenoid valves 23, 25, and 27 each have a blocking position and a passage position and are, for example, spring pre-tensioned in the deenergized passage position as “normally open” valves, while they assume their blocking position upon being energized.

The remaining elements of the electrohydraulic brake 100, such as the electronic controller 1, the braking value generator 19, and the control unit 22 of the driver assistance system or the autopilot are not shown in FIG. 7, but are nonetheless present and interact with one another as described above.

For the brake pressure build-up or for the brake actuation without ABS regulation function, the drive machine 5 of the pump 4 is controlled by the electronic controller 1 in such a way that the pump 4, in its single pump direction, conveys hydraulic fluid from the hydraulic fluid reservoir 3 via the first flow connection 24 into the brake actuator 2. The first 2/2 way solenoid valve 23 is switched by the electronic controller 1 into the passage position, while the second 2/2 way solenoid valve 25 and the third 2/2 way solenoid valve 27 are switched into their blocking position.

To release the brakes, the drive machine 5 of the pump 4 is deactivated, i.e. it does not rotate, and the second 2/2 way solenoid valve 25 is switched into its passage position, while the first 2/2 way solenoid valve 23 and the third 2/2 way solenoid valve 27 are each switched into the blocking position. Hydraulic fluid thus flows through the open second 2/2 way solenoid valve 25 and the second flow connection 26 back into the hydraulic fluid reservoir 3.

For a brake pressure reduction in the course of an ABS regulating cycle, the electronic controller 1 controls each of the first and second 2/2 way solenoid valves 23, 25 into the blocking position, but the third 2/2 way solenoid valve 27 into the passage position, so that hydraulic fluid flows from the at least one brake actuator 2 into the pressure accumulator 8 via the open third 2/2 way solenoid valve 27 and the third flow connection 28 in order to increase the pressure therein.

If subsequently maintaining pressure is part of the ABS regulating cycle, the third 2/2 way solenoid valve 27 is switched, for example, from the passage position into the blocking position, in which the first and second 2/2 way solenoid valves 23, 25 are then also still located.

For a subsequent brake pressure build-up in the course of the ABS regulating cycle, the drive machine 5 of the pump 4 is again controlled so that the pump 4 pumps, in its single pump direction, hydraulic fluid from the hydraulic fluid reservoir 3 via the first flow connection 24 into the at least one brake actuator 2. For this purpose, the first 2/2 way solenoid valve 23 is also switched from the blocking position into the passage position. Furthermore, the third 2/2 way solenoid valve 27 is switched into the passage position, so that hydraulic fluid previously conveyed into the pressure accumulator 8 and increasing the pressure therein during the brake pressure reduction can flow back into the at least one brake actuator 2. The pressure in the pressure accumulator 8 then acts in addition to the pressure in the at least one brake actuator 2, which is built up by the pump 4.

As a result, upon each change from a brake pressure reduction to a brake pressure build-up and vice versa, hydraulic fluid also flows in the exemplary embodiment of FIG. 7 back and forth into the pressure accumulator 8 with pressure increase therein and out of the pressure accumulator 8 with pressure reduction therein.

If a malfunction then occurs in the electronics, for example, in the course of a power failure, the three 2/2 way solenoid valves 23, 25, and 27 are deenergized and then switch in a spring pre-tensioned manner into their passage position. As a result, hydraulic fluid then flows from the at least one brake actuator 2 through the open second 2/2 way solenoid valve 25 via the second flow connection 26 into the hydraulic fluid reservoir 3, due to which the at least one brake actuator 2 is set force-free and therefore a fail-silent function is provided.

In each of the above-described exemplary embodiments, a wheel-individual brake pressure build-up or brake pressure reduction is described. However, it is clear that the brake pressure build-up and the brake pressure reduction can also be carried out axle by axle, i.e. for all brake actuators 2 on one axle.

### LIST OF REFERENCE SIGNS

1 controller
2 brake actuator
3 hydraulic fluid reservoir
4 pump
5 drive machine
6 first connection
7 second connection
8 pressure accumulator
9 valve device
10 3/2 way solenoid valve
11 first check valve
12 second check valve
13 first flow connection
14 first connection
15 second flow connection
16 second connection
17 third flow connection
18 third connection
19 braking value generator
20 signal line
21 brake pedal
22 control unit
23 first 2/2 way solenoid valve
24 first flow connection
25 second 2/2 way solenoid valve
26 second flow connection
27 third 2/2 way solenoid valve
28 third flow connection
100 electrohydraulic brake

1. An electrohydraulic brake for a vehicle, comprising:
a) an electronic controller having an implemented regulation function, which is carried out during a braking operation as needed in at least one regulating cycle, wherein during the regulating cycle, at least one brake pressure reduction and at least one brake pressure build-up take place in at least one hydraulic brake actuator,
b) the at least one hydraulic brake actuator, which generates a braking force depending on the introduced brake pressure,
c) a hydraulic fluid reservoir for depressurized storage of hydraulic fluid,
d) a pump and a drive machine for the pump,
e) at least one pressure accumulator for pressurized storage of hydraulic fluid which originates from the hydraulic fluid reservoir,
f) flow connections between the at least one brake actuator, the hydraulic fluid reservoir, the pump, and the pressure accumulator, wherein
g) in at least one flow connection, a valve device at least partially controllable by the electronic controller is arranged, which controls a flow of hydraulic fluid in the at least one flow connection, wherein
h) the electronic controller controls at least the drive machine for the pump and/or the valve device such that during the at least one regulating cycle, hydraulic fluid flows back and forth or is conveyed back and forth between the at least one brake actuator and the pressure accumulator.

2. The electrohydraulic brake of claim 1, wherein the electronic controller is configured such that, during the at least one regulating cycle, it controls the drive machine of the pump and/or the valve device
a) for the brake pressure reduction such that hydraulic fluid flows or is conveyed from the at least one brake actuator into the pressure accumulator, and
b) for the brake pressure build-up such that hydraulic fluid flows or is conveyed from the pressure accumulator into the at least one brake actuator.

3. The electrohydraulic brake in claim 1, that wherein the regulation function is configured so that at least during the at least one regulating cycle, at least one brake pressure maintenance following a brake pressure build-up or a brake pressure reduction is carried out, in which the electronic controller controls the drive machine of the pump and/or the valve device such that hydraulic fluid is retained in the at least one brake actuator.

4. The electrohydraulic brake of claim 1, wherein the electronic controller controls at least the drive machine of the pump and/or the valve device such that, with inactive regulation function
a) for a brake pressure build-up in the at least one brake actuator, hydraulic fluid flows or is conveyed from the hydraulic fluid reservoir and/or from the pressure accumulator into the at least one brake actuator, and
b) for a brake pressure reduction, hydraulic fluid flows or is conveyed from the at least one brake actuator into the hydraulic fluid reservoir.

5. The electrohydraulic brake of claim 1, wherein it comprises a braking request device, which introduces signals for the beginning and the ending of the braking operation and for the degree of brake actuation of the brake into the electronic controller to control the braking operation, and which comprises
a) a braking value generator actuatable by a driver of the vehicle, and/or
b) a driver assistance system and/or an autopilot.

6. The electrohydraulic brake of claim 1, wherein the pump is a unidirectionally operable pump having a single conveyance direction, wherein the electronic controller controls the drive machine of the unidirectionally operable pump such that the unidirectionally operable pump conveys hydraulic fluid in the single conveyance direction.

7. The electrohydraulic brake as claimed in of claim 6, characterized in that wherein the operation of the unidirectionally operable pump in the single conveyance direction is carried out for the brake pressure build-up.

8. The electrohydraulic brake of claim 1, wherein the pump is a bidirectionally operable pump, wherein the electronic controller controls the drive machine of the pump such that the bidirectionally operable pump
a) in a first conveyance direction, conveys hydraulic fluid from the hydraulic fluid reservoir and/or from the pressure accumulator into the at least one brake actuator, and
b) in a second conveyance direction opposite to the first conveyance direction, conveys hydraulic fluid from the at least one brake actuator into the pressure accumulator and/or into the hydraulic fluid reservoir.

9. The electrohydraulic brake of claim 8, wherein the operation of the bidirectionally operable pump
a) takes place in the first conveyance direction for the brake pressure build-up, and
b) takes place in the second conveyance direction for the brake pressure reduction.

10. The electrohydraulic brake of claim 9, wherein the electronic controller controls the drive machine of the pump at least during the at least one regulating cycle such that the pump is alternately operated between the first conveyance direction and the second conveyance direction for the brake pressure reduction and for the brake pressure build-up.

11. The electrohydraulic brake of claim 1, wherein the regulation function comprises a wheel-individual or axle-individual antilock braking system or traction control system and/or a driving dynamics control.

12. The electrohydraulic brake of claim 1, wherein the electronic controller is configured such that, during a filling phase, it controls the drive machine of the pump and the valve device in order to convey hydraulic fluid into the pressure accumulator until the pressure prevailing in the pressure accumulator is greater than a minimum pressure.

13. The electrohydraulic brake of claim 12, wherein the minimum pressure is in a range between 50 and 100 bar.

14. The electrohydraulic brake of claim 1, wherein the valve device comprises at least one solenoid valve controlled by the electronic controller and the valve device has at least one switching position, in which the valve device establishes a flow connection between the at least one brake actuator and the pressure accumulator and/or the hydraulic fluid reservoir.

15. The electrohydraulic brake of claim 14, wherein the solenoid valve is spring pre-tensioned in the one switching position and assumes the one switching position when deenergized.

16. The electrohydraulic brake of claims 13, wherein the valve device comprises at least one or more of the following:
a) a check valve,
b) a 2/2 way solenoid valve,
c) a 3/2 way solenoid valve, and
d) a 4/2 way solenoid valve.

17. A vehicle comprising the electrohydraulic brake of claim 1.
